(19) United States
(12) Patent Application Publication
(10) Pub. No.: US 2012/0109661 A1
(43) Pub. Date: May 3, 2012

(54) ASSOCIATIVE INFORMATION LINKING FOR BUSINESS OBJECTS

(75) Inventor: Hermann Lueckhoff, Sunnyvale, CA (US)

(73) Assignee: SAP AG, Walldorf (DE)

(21) Appl. No.: 12/913,610

(22) Filed: Oct. 27, 2010

(51) Int. Cl. G06Q 10/00

(52) U.S. Cl. 705/1.1

(57) ABSTRACT

A method to create or modify a data item of a first application based on a data item of a business object of a second application or to create or modify the data item of the business object based on the data item of the first application is disclosed. The method includes detecting, using a processor, an interaction of a user of the first application with respect to the visual representation of the business object. Additionally, the method includes performing, in response to the detecting, at least one of creating or modifying the data item of the first application based on the data item of the business object of the second application and creating or modifying the data item of the business object based on the data item of the first application.

### TECHNICAL FIELD

The present application relates generally to the field of annotating business objects of software applications, and, in one specific example, to annotating a business object of a first software application based on an interaction of a user with respect to a visual representation of the business object presented in a user interface of a second software application.

### BACKGROUND

Employees of a company or enterprise may be more familiar with some software applications than others. For example, the employees may be very familiar with personal productivity applications (e.g., Microsoft Outlook), but they may not be as familiar with back-end business software applications (e.g., business intelligence; enterprise information management; enterprise performance management; governance, risk, and compliance; analytic software applications). In particular, employees may not be familiar with business objects of the back-end applications, much less how to access such business objects.

### BRIEF DESCRIPTION OF THE DRAWINGS

Some embodiments are illustrated by way of example and not limitation in the figures of the accompanying drawings in which:

FIG. 1 is a block diagram depicting an example environment within which example embodiments may be deployed;

FIG. 2 is a block diagram depicting example modules of a plug-in of FIG. 1;

FIG. 3 is a screenshot depicting an example user interface of a first software application in which a visual representation of a business object of a second application is presented;

FIG. 4 is another screenshot depicting an example user interface of a first software application in which a visual representation of a business object of a second application is presented;

FIG. 5 is a further screenshot depicting an example user interface of a first software application in which a visual representation of a business object of a second application is presented along with an annotation of the business object;

FIG. 6 is a screenshot depicting a portion of an example user interface of a first software application in which a box is provided for inputting a search string element of a search query to find particular business objects of a back-end software application;

FIG. 7 is a screenshot depicting a portion of an example user interface of a first software application for selecting a particular action to perform with respect to a business object of a second application;

FIG. 8 is a screenshot depicting an example user interface of a first software application in which a data item of a first application is updated to include multiple data items associated with a business object of a second application;

FIG. 9 is a flowchart depicting an example method of creating or modifying a data item of a first application based on the data item of a business object of a second application or creating or modifying the data item of the business object based on the data item of the first application;

FIG. 10 is a flowchart depicting an example method of creating or modifying a data item of a business object of a second application based on a selection of the user of one of a plurality of data items of a first application;

FIG. 11 is a flowchart depicting an example method of displaying a visual representation of a business object of a second application that matches a query submitted by a user via a user interface of a first application;

FIG. 12 is a flowchart depicting an example method of invoking functionalities of an application based on interactions of a user in an additional application with respect to visual representations of portions of a metamodel of the application presented in the additional application;

FIG. 13 is a flowchart depicting an example method of associating a data item of a first application with a data item of a business object of a second application; and

FIG. 14 is a block diagram of an example computer system on which methodologies described herein may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, to avoid obscuring the inventive subject matter in unnecessary detail, well-known instruction instances, protocols, structures, and techniques have not been shown in detail. As used herein, the term “or” may be construed in an inclusive or exclusive sense. The term “user” may be construed to include a person or a machine. The term “interface” may be construed to include an application program interface (API) or a user interface. The term “database” may be construed to include a database or a NoSQL or non-relational data store (e.g., Google's BigTable or Amazon's Dynamo). The term “business object” may mean an object that represents an entity of a business inside a software application. For example, a business object may represent a person (e.g., an employee of a company) or a concept (e.g., a process within a company) inside an enterprise information management software application.

A method to create or modify a data item of a first application based on a data item of a business object of a second application or to create or modify the data item of the business object based on the data item of the first application is disclosed. The method includes detecting, using a processor, an interaction of a user of the first application with respect to the visual representation of the business object. Additionally, the method includes performing, in response to the detecting, at least one of creating or modifying the data item of the first application based on the data item of the business object of the second application and creating or modifying the data item of the business object based on the data item of the first application.

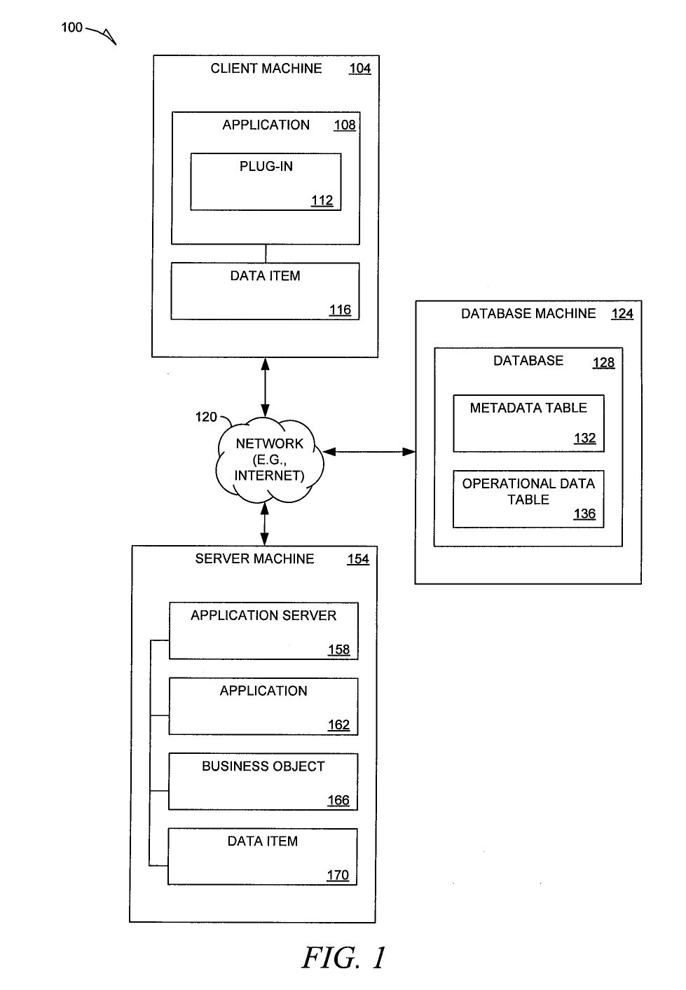

FIG. 1 is a block diagram depicting an example environment 100 within which example embodiments may be deployed. The environment 100 includes one or more client machines (e.g., client machine 104). For example, the client machine 104 may be a personal computer of an employee of a company. The client machine 104 executes one or more software applications (e.g., application 108). For example, the application 108 may be a personal productivity software application, such as Microsoft Outlook. The application 108 manages one or more data items (e.g., data item 116). The data item 116 may be any unit of data managed by application 108. For example, data item 116 may be an email message or a portion of an email message (e.g., a subject, body, list of direct (To-line) recipients, list of carbon-copied (Cc-line) recipients, header, and so on, of the email message).

The application 108 includes one or more plug-ins (e.g., plug-in 112). Although referred to herein as a “plug-in,” the plug-in 112 may not be a plug-in at all, but rather a standalone software application. For example, the plug-in 112 may be a desktop widget on which a user may drop any kind of object, such as an email, a browser link, a document, and so on. The plug-in 112 provides a mechanism for a user of the application 108 to access one or more business objects (e.g., business object 166) of one or more additional applications (e.g., application 162) via a user interface of application 108. For example, the plug-in 112 may use native user interface elements of the application 108 to display a business object view (or window) inside a main window of the application 108. In the business object view, the plug-in 112 may display (e.g., using a tree control) a visual representation of the business object 166. The visual representation of the business object 166 may include a visual representation of one or more data items (e.g., data item 170) of the business object. A data item of the business object may be a unit of data corresponding to the business object that is managed by an application that provides the business object. The visual representation of the business object 166 may include a diagram of the relationships between the business object 166 and the one or more data items 170 of the business object 166. The visual representation of the business object 166 may also include a diagram of the relationships between the one or more data items 170 of the business object 166.

The environment 100 includes one or more server machines (e.g., server machine 154). The server machine 154 executes one or more application servers (e.g., application server 158). The server machine 154 also executes the one or more additional software applications (e.g., the application 162). For example, the server machine 154 may execute the application 162 in conjunction with the application server 158. The application 162 includes a business object (e.g., business object 166). The business object 166 may correspond to one or more entities within the application 162 that represent things in a business to which the application 162 pertains. For example, the business object 166 may map a source data structure in a database (e.g., database 128) to business terms used by non-Information Technology analysts. The business object 166 may also correspond to a function of the database 128 or the application 162. For example, if the application 162 is a Human Resources application pertaining to recruiting of candidates for job openings within a company, the business object 166 may correspond to a person (e.g., a job candidate) who has applied for a job opening. The business object 166 may include one or more data items (e.g., data item 170). The data items 170 of the business object 166 may correspond to any data that the one or more additional applications 162 maintain with respect to the business object 166. For example, the data item 170 may be a resume of a person (e.g., a candidate for an open position at a company) represented by the business object 166 or the data item 170 may be a time card of a person (e.g., an employee of a company) represented by the business object 166.

The environment 100 includes one or more database machines (e.g., database machine 124). The database machine 124 includes one or more databases (e.g., database 128). The database 128 includes one or more tables maintained by the plug-in 112, including a metadata table 132 and an operational data table 136. The metadata table 132 includes data pertaining to a configuration (e.g., an appearance or behavior) of the plug-in 112. The operational data table 136 includes data that describes or annotates associations between the business object 166 and the data item 170 of the business object 166 (or between the data item 170 and an additional data item of the business object 166) of the additional application 162. This operational data table 136 may be associated with a metamodel of the business object 166. The metamodel may define associations between the business object 166 and additional business objects, between the business object 166 and data items of the business object 166, or between data items of the business object 166 or data items of the additional business objects. The metamodel may also define actions that the business object 166 supports (e.g., an “Attach” action to attach an email message or attachment of an email message to the business object 166). The metamodel may also define how actions are to be rendered by the plug-in 112 (e.g., as a context menu or as a popup menu after a drag-and-drop operation). The database 128 may also include source tables (not shown) from which the business object 166 of the application 162 may be derived.

The client machine 104, database machine 124, and server machine 154 may be coupled to each other via a network 120. The network 120 enables communication between systems. Accordingly, the network 120 may be a mobile telephone network, a Plain Old Telephone (POTS) network, a wired network, a wireless network (e.g., a WiFi or WiMax network), or any suitable combination thereof. The communication may be based on any communication protocols. Examples of communication protocols include Transmission Control Protocol/Internet Protocol (TCP/IP), HyperText Transfer Protocol (HTTP), File Transfer Protocol (FTP), Simple Mail Transfer Protocol (SMTP), Post Office Protocol (POP), Internet Message Access Protocol (IMAP), Wireless Access Protocol (WAP), Gopher, wireless internet protocols, and instant messaging protocols. The network 120 may be implemented using the Internet, a wide area network (WAN), a local area network (LAN), or any suitable combination thereof.

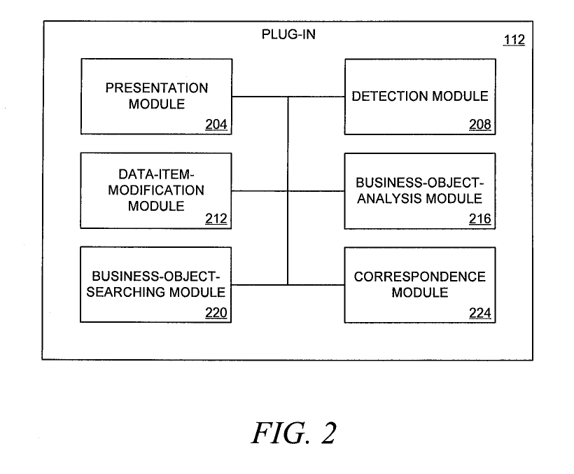

FIG. 2 is a block diagram depicting example modules of the plug-in 112 of FIG. 1. The plug-in 112 includes a presentation module 204 to present a user interface in a first application (e.g., the application 108) to enable a user to access (e.g., create or modify) a business object (e.g., the business object 166) of a second application (e.g., the application 162). For example, the presentation module 204 may use the native user interface element of the application 108 to display a visual representation of the business object 166 in a user interface element (e.g., a window) of application 108. The presentation module 204 may also present visual representations of the data item 170 of the business object 166. The presentation module 204 may also present a diagram of the relationships between the business object 166 and the data item 170 of the business object 166 (or between the data item 170 and an additional data item of the business object 166).

The presentation module 204 may also manage color-coding of each data item 170 based on its type. For example, a data item representing a state of the business object 166 that is maintained by the additional application 162 may be color-coded red; a data item that is merely associated with the business object 166 of the additional application 162 (e.g., a data item that is maintained externally from the additional application 162 by the plug-in 112) may be color-coded blue; a non-state data item (e.g., a data item representing an action that is to be performed by the additional application 162 with respect to business object 166) may be color-coded yellow. The presentation module 204 may also use a user interface element of the application 108 to present a user interface to enable a user to search for particular business objects of the application 162 from within the application 108.

The presentation module 204 may also display (e.g., in a native user interface element of application 108) information about the business object 166 (e.g., a business object selected by a user). For example, if the business object corresponds to a person, the presentation module 204 may display information about the person, such as the person's first name, last name, email address, phone number, and position. The presentation module 204 may also display metadata about the business object 166, such as a group of business objects to which a currently highlighted business object 166 belongs (e.g., “People”).

The plug-in 112 includes a detection module 208 to detect an action of the user within the application 108. For example, the detection module 208 may detect an action of the user with respect to the visual representation of the business object 166 or a visual representation of the data item 166, or a visual representation of the data item 116. The detection module 208 may detect, for example, a mouse hover, click, double-click, drag, drop, and scroll events. The type of user interface presented by the presentation module 204 may depend on the type of the client machine 104 (e.g., whether the client machine 104 is a personal computer or a personal digital assistant (e.g., an iPhone)). Thus, the detection module 208 may detect additional types of interactions of the user with respect to the user interface, such as gestures of the user or interactions of the user with respect to a context menu. The detection module 208 may detect when a user drags and drops a visual representation of data item 116 onto the visual representation of the business object 166 or onto a visual representation of a data item 170 associated with the business object 166. In addition, the detection module 208 may detect when the user drags and drops the visual representation of the business object 166 or a visual representation of the data item 170 associated with the business object 166 onto a visual representation of a data item 116 associated with the application 108.

The plug-in 112 includes a data-item-modification module 212 to create or modify a data item (e.g., data item 116) of a first application (e.g., application 108) based on a business object (e.g., business object 166) of a second application (or a data item of the business object of the second application), or vice versa. For example, the data-item-modification module 212 may modify the data item 170 based on the data item 116 in response to a detecting by the detection module 208 of a dragging and dropping by the user of a visual representation of the data item 116 onto a visual representation of data item 170. In this case, the data-item-modification module 212 may update portions of the data item 170 such that the data item 170 is in synchronization with the data item 116. Alternatively, the data-item-modification module 212 may replace the content of the data item 170 with the content of the data item 116.

As another example, the data-item-modification module 212 may create a new data item for the business object 166 based on detection by the detection module 208 of an action by the user (e.g., a dragging and dropping by the user of a visual representation of the data item 116 onto a visual representation of the business object 166). In this case, the data-item-modification module 212 may create a new data item for the business object 166 that is similar, or identical to, the data item 116. This creation of a new data item may be based on an identification by the data-item-modification module 212 that a data item corresponding to the data item 116 does not exist for the business object 166. This new data item may be associated with the business object 166 via a registration with the application 162 that provides the business object 166 (e.g., via a call to an API) or be associated with the business object 166 independently of the application 162 that provides the business object 166.

As another example, the data-item-modification module 212 may create a new data item for the application 116 that is an attachment to the data item 116 based on, for example, a dragging and dropping of a visual representation of an attachment (e.g., data item 170) of the business object 166 onto a visual representation of the data item 116. Thus, for example, the detection module 208 may detect a dragging and dropping by a user of multiple visual representations of multiple data items (e.g., timesheet records) of business object 166 (e.g., an object corresponding to an employee of a company) onto a visual representation of data item 116 (e.g., an email message). In response, the data-item-modification module 212 may add multiple new data items to application 108 as attachments to data item 116. For example, if data item 116 is an email message, the data-item-modification module 212 may add the multiple data items of the business object to the email message as attachments to the email message. The data-item-modification module 212 may then store the attachments in the operational data table 136 such that the data-item-modification module 212 may manage the attachments independently of application 162.

The plug-in 112 further includes a business-object-analysis module 216 to identify relationships between the business objects of an application, between each of the business objects and their associated data items, and between each of the associated data items. The business-object-analysis module 216 may identify the relationships based on a querying of the applications containing the business objects (e.g., via an API of the applications). The business-object-analysis module 216 may also identify the relationships by analyzing the metamodel of the relationships.

The metamodel may include definitions not only of relationships between business objects (and data items of the business objects) that are maintained by an application that provides the business objects (e.g., relationships obtained from a querying of the application), but it may also include definitions of relationships pertaining to data items that are not maintained by the application that provides the business objects. For example, the business-object-analysis module 216 may identify the relationships based on a definition included in the metamodel by the plug-in 112. The metamodel may include definitions of relationships between business objects and data items of the business objects (or between data items of the business objects) that are independent of the applications that provide the business object. For example, the metamodel may include a definition of a relationship between a resume of a person and a business object that represents the person even if the application that provides the business object is unaware of such a relationship. Additionally or alternatively, definitions of relationships that are independent of the application that provides the business object may be stored separately from the metamodel (e.g., such definitions may be maintained by the application 108). The presentation module 204 may present the relationship between the resume and the person in the visual representation of the business object independently of any recognition by the application of such a relationship. In this way, the business-object-analysis module 216 enables a user to associate any data item of any application with any business object of any application. The business-object-analysis module 216 may maintain definitions of relationships in the operational data table 136 in accordance with one embodiment.

In example embodiments, the plug-in 112 also includes a business-object-searching module 220 to search for one or more business objects (e.g., business object 166) associated with one or more applications (e.g., application 162). The business-object-searching module 220 may present a query user interface (e.g., using the presentation module 204) to a user. The query user interface may include one or more fields, each having a set of predefined values, to allow the user to easily formulate a query. For example, the query user interface may include a “Search In” drop-down menu box that includes pre-defined values to search for business objects by application or category (e.g., “Contractor Management”).

The query user interface may include a “For” drop-down menu box that includes pre-defined values to search for a particular type of business object (e.g., “People”). The query user interface may further include a “Search String” drop-down box to search for business objects containing a particular search string (e.g., an email address). The query user interface may include a mechanism (e.g., a “Go” button) to instruct the business-object-searching module 220 to begin processing the query. The business-object-searching module 220 may process the query by sending a request to an application (e.g., application 162) to return a set of business objects identified by the query. Additionally or alternatively, the business-object-searching module 220 may analyze the metamodel (described above) to identify business objects that correspond to the query.

In example embodiments, the plug-in 112 further includes a correspondence module 224 to determine correspondences or relationships between one or more data items of a first application (e.g., the application 108) and one or more business objects (e.g., the business object 166) of a second application (e.g., the application 162) or between one or more data items of a first application and one or more data items (e.g., the data item 170) of the business objects of the second application. For example, the correspondence module 224 may determine that a data item of the application 108 (e.g., a name specified in the From: line of an email message) corresponds to a business object corresponding to a person who sent the email message. The correspondence module 224 may use this knowledge to pre-populate the fields of the query user interface (described above) based on a detection (e.g., by the detection module 208) of a dragging and dropping by the user of the email message onto the query user interface. Alternatively, the correspondence module 224 may automatically find a business object of a second application that corresponds to a data item that is the focus of a user action in the first application. After finding the business object, the correspondence module 224 may present (e.g., using the presentation module 204) a visual representation of the business object in the first application. In this way, the correspondence module 224 may ensure that a context or actions of the user of the first application control which business objects of the second application are displayed for access or manipulation within the user interface of the first application. In example embodiments, the first application and the second application are running on different machines (e.g., the client machine 104 and the server machine 154, respectively).

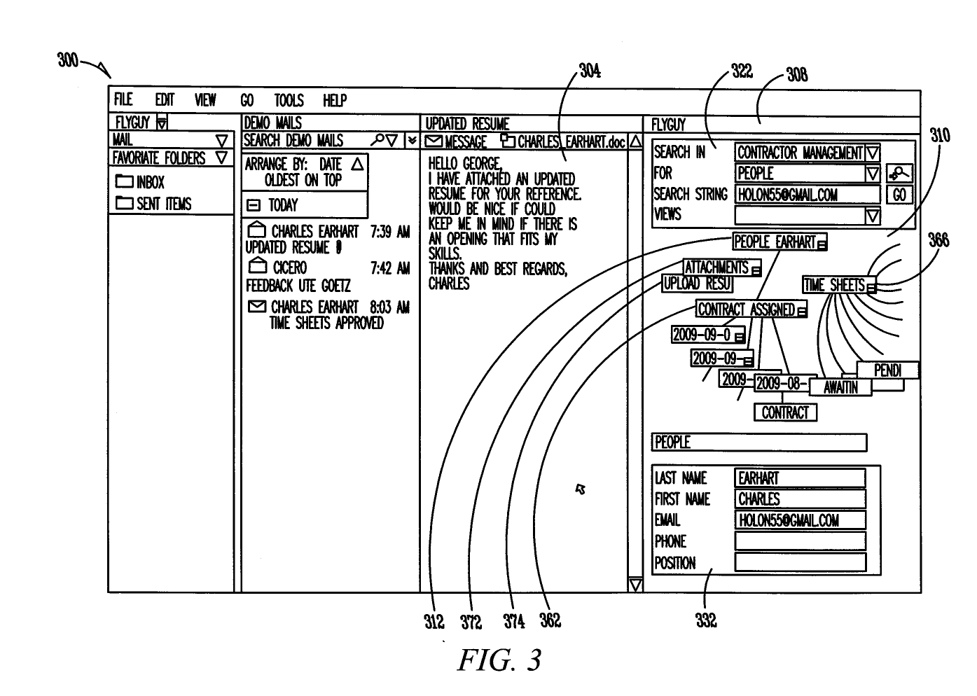

FIG. 3 is a screenshot depicting an example user interface 300 of a first software application in which a visual representation of a business object of a second software application is presented. In this case, the first software application is Microsoft Outlook and the second software application is a back-end enterprise information management application. Furthermore, the plug-in 112 has been installed and configured to work with Microsoft Outlook. George, a recruiter for a company, is very familiar with Microsoft Outlook, but he is not familiar with the back-end enterprise information management application. In Microsoft Outlook, George receives an email from Charles Earhart. Charles is a contractor who has worked for the company in the past. Charles asks George to update the company's records with Charles' latest resume. The presentation module 204 displays a business objects window 308 (e.g., “FlyGuy”) that enables George to access or manipulate business objects of the back-end enterprise information management application from within Microsoft Outlook. The detection module 208 may detect when George opens an email message 304 or when George drags and drops the email message over the business objects window 308.

Additionally, the correspondence module 224 identifies that the data item of Microsoft Outlook that is the focus of George's action within Microsoft Outlook is the email message 304. Furthermore, the correspondence module 224 identifies various fields or elements associated with the email message 304, including a To:, From:, Subject:, and body fields of the email message 304, and the values corresponding to the fields. The correspondence module 224 identifies that the value of the From: field of the email message corresponds to a person named “Charles Earhart.” In response, the correspondence module 224 searches (e.g., using the business-object-searching module 220) for a business object of the enterprise management application that corresponds to Charles Earhart. The correspondence module 224 may find the business object by querying the enterprise management application or analyzing a metamodel associated with the enterprise management application. In this case, the correspondence module 224 may determine that the enterprise management application maintains business objects of the type “Person” that include data related to people who are current or past employees of the company or who are interested in becoming employees of the company. One of these business objects includes data items (e.g., First Name, Last Name, and Email address) that correspond to the fields or elements of the email message. In this way, the correspondence module 224 determines that the email message 304 that George received in Microsoft Outlook from Charles Earhart corresponds to the business object “Person Earhart” of the enterprise information management application.

Upon an identification of the correspondence between the email message 304 that George received in Microsoft Outlook and a business object of the enterprise information management application, the presentation module 204 displays a visual representation 312 of the business object in a portion 310 of the business objects window 308. Additionally, the presentation module 204 displays visual representations of data items of the business object. The visual representations show the relationships between the business object and the data items of the business object (e.g., with connecting lines). The visual representations may also show the relationships between the data items of the business object.

In this case, the data items of the business object include data items corresponding to information about contract assignments that Charles previously completed (e.g., dates of employment), each of which is associated with a data item 362 representing a folder for the information about the contract assignments. The data items of the business object also include data items corresponding to timesheets that Charles previously submitted, each of which is associated with a data item 366 representing a folder for the timesheets. In other portions of the business objects window 308, the presentation module 204 displays visual representations of additional data items of the business object, or elements (or fields) of the data items, along with their respective values. For example, the presentation module 204 displays a query user interface 322 that includes fields and values corresponding to a category (e.g., “ContractManagement”) of business objects to which the business object belongs, a group or type (e.g., “People”) of business objects to which the business subject belongs, and a Search String (e.g., an email address) that may be used to identify the business object within a set of business objects that an application provides. The presentation module 204 also displays detailed view pane 332 that includes fields and values corresponding a last name (e.g., “Earhart”), a first name (e.g., “Charles”), and an email address related to the business object.

When George drags and drops the email message 304 over the visual representation 362 of the business object, which is an action that the detection module 208 detects, the data-item-modification module 212 modifies the business object based on the email message 304. In this case, the data-item-modification module 212 adds a new data item representing a folder (e.g., “Attachments”) to the business object. The data-item-modification module 212 then associates the folder with a new data item representing attachments to the business object. For example, the data-item-modification module 212 adds Charles' resume (e.g., a Microsoft Word document entitled “Charles Earhart.doc”), which is attached to the email message, to the business object as a new data item. The data-item-modification module 212 may also add data items corresponding to other elements or fields of the email message to the business object. To determine which elements or fields of the email message to associate with the business object, the data-item-modification module 212 may prompt the user to select from available elements or fields, such as elements or fields identified by the correspondence module 224. The data-item-modification module 212 also defines the relationship between the business object and the two new data items. In particular, the data-item-modification module 212 specifies that the “Attachments” data item is a first-level data item of the business object and that Charles' resume is a second-level data item of the business object that is associated with the “Attachments” data item. The presentation module 204 presents in the portion 310 of the business objects window 308 a visual representation 372 corresponding to the new data item for the “Attachments” folder and a visual representation 374 corresponding to the new data item for the document containing Charles' resume.

The data-item-modification module 212 may add the new data items such that they correspond to data items that the enterprise information management application maintains. For example, the data-item-modification module 212 may invoke an API of the enterprise information management application to create the data items and associate them with the business object. Additionally or alternatively, the data-item-modification module 212 may add the new data items such that they are annotations of the business object that are maintained by the data-item-modification module 212 independently of the enterprise information management application. For example, the data-item-modification module 212 may cause the application 162 to store the new data items in a metamodel. In other words, the data-item-modification module 212 may define the relationships between the business object and the new data items or the relationships between the data items such that the enterprise information management application is aware of the relationships (e.g., via an API). Or the data-item-modification module 212 may specify and maintain the definitions of the relationships externally from (or independently of) the enterprise information management application. For example, the data-item-modification module 212 may specify and maintain the relationships in the operational data table 136.

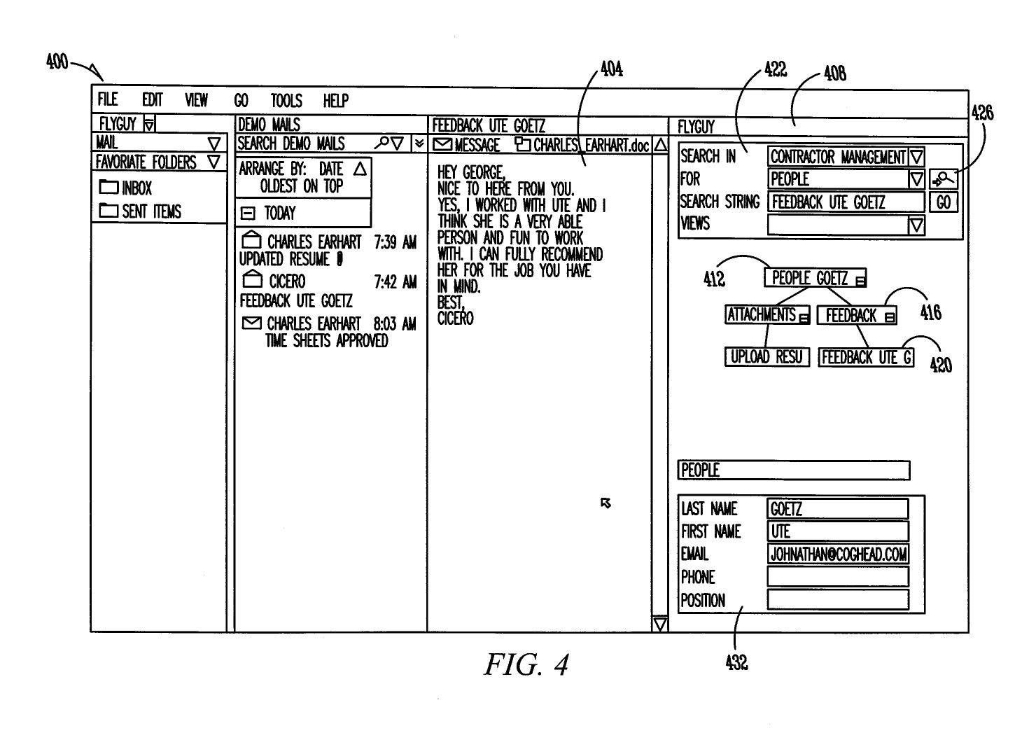

FIG. 4 is a screenshot depicting an example user interface 400 of a first software application in which a visual representation 412 of a business object of a second application is presented. In this case, the first software application is Microsoft Outlook and the second software application is a back-end enterprise information management application. Furthermore, the plug-in 112 has been installed and configured to work with Microsoft Outlook. In this example, Ute Goetz is a candidate for a job at a company. George is a recruiter at the company. George receives an email message 404 from Cicero, who previously worked with Ute Goetz. In the email message 404, Cicero provides a recommendation to George that the company hire Ute Goetz for the job. In response to an interaction by George with respect to the email message 404 and the business objects window 408 (e.g., in response to a dragging and dropping by George of the email message 404 on the business objects window 408), the presentation module 204 displays a visual representation 412 of a business object (e.g., “People Goetz”) of the back-end enterprise information management application that corresponds to the email message 404.

The process by which the plug-in 112 determines a relationship between the email message 404 and a business object of the back-end enterprise information management application is similar to the process described above with respect to FIG. 3. The business-object-searching module 220 finds a business object of the enterprise information management application that corresponds to the email message 404. For example, the business-object-searching module 220 queries the enterprise information management application for a business object having a particular category (e.g., “ContractManagement”), a particular type (e.g., “People”), and particular text (e.g., “Feedback Ute Goetz”). The query may be performed automatically. Alternatively, the query may be performed in response to an action by George (e.g., a pressing of a “Go” button of a query user interface). The fields of the query may be presented to George in a query user interface 422. Furthermore, the fields of the query may be pre-populated with values corresponding to a data item (e.g., an email message) that relates to George's user context within Microsoft Outlook (e.g., a data item that is a focus of George's actions).

The correspondence module 224 identifies a relationship between the email message and the business object (e.g., based on an element or field (e.g., the content of the subject line) of the email message and one or more data items (e.g., Last Name, First Name, email address) of the business object. The data-item-modification module 212 modifies the business object by adding or modifying one or more new data item. For example, the data-item-modification module 212 adds a new data item that represents a “Feedback” folder for the business object and adds a new data item that contains feedback relevant to the business object that was received in the email message 404. The presentation module 204 then presents visual representations 416 and 420 of these new data items (e.g., a square box containing the word “Feedback” that corresponds to the new data item for the Feedback folder and a square box containing the phrase “Feedback Ute G” that corresponds to the new data item for the feedback from the email message 404), as well as visual representations of the associations between these new data items and the business object (e.g., a line connecting the visual representation 412 of the business object to the visual representation 416 of the feedback folder, and a line connecting the visual representation 416 of the feedback folder to the visual representation 420 of the feedback from the email message 404), in the business objects window 408. The data-item-modification module 212 also creates or updates definitions of the relationships between the business object and the new data items that are added to the business object. The data-item-modification module 212 may add each new data item or relationship definition to the business object such that it is maintained by the application that provides the business object (e.g., via an API of the application that provides the business object) or added such that it is an annotation of the business object that is maintained by the data-item-modification module 212 (e.g., in the operational data table 136).

The business objects window may include a query user interface 422. The query user interface 422 may include user interface elements corresponding to fields of a query that a user may submit to search for business objects within (or provided by) the second application. For example, the query user interface 422 may include a drop-down menu box (e.g., with a “Search In” label) from which a user of the first application can select a business object category from among the possible business object categories for inclusion in the query. The query user interface 422 may also include a drop-down menu box (e.g., with a “For” label) from which a user of the first application may select a type of business object (e.g., “People”) from among the possible business object types for inclusion in the query. Additionally, the query user interface 422 may include a box (e.g., with a “Search String” label) in which a user may enter a search string for inclusion in the query.

Furthermore, the query user interface 422 may also include a quick entry button 426. Each time a user of the first application presses the quick entry button 426, potential search strings are entered into the search string box automatically. The correspondence module 224 may derive the potential search strings from the content of a data item (e.g., an email message) of the first application. For example, each time the user presses the quick entry button 426, the correspondence module 224 may identify a different element of an email message to include in the search string box. For example, the correspondence module 224 may identify the subject, the sender, the recipient, or the header information of the email message to include in the Search String box. Additionally, the correspondence module 224 (e.g., in conjunction with the presentation module 204) may prepopulate the fields presented in the query user interface 422 based on the data item of the first application.

The business object window 408 may include a detailed view pane 432 that provides data or metadata associated with a visual representation presented in the business objects window. For example, when the user selects the visual representation 412 of the business object corresponding to a person (e.g., Ute Goetz), a detailed view pane 432 may include user interface elements corresponding to data associated with the business object, such as the last name, first name, e-mail address, phone number, and company position of the person.

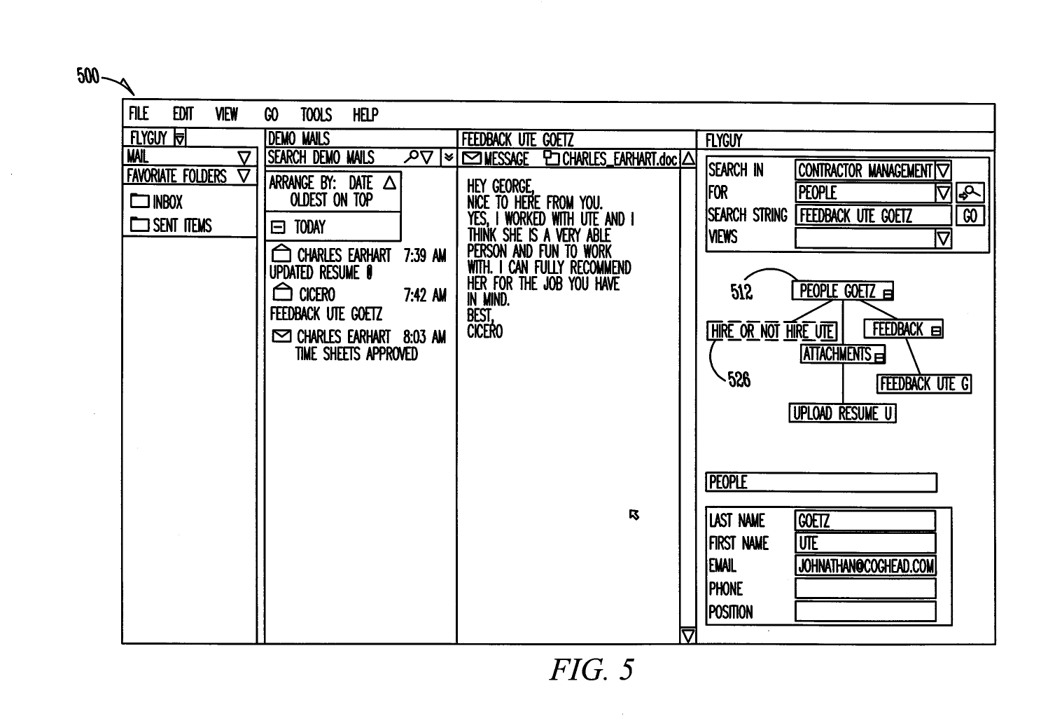

FIG. 5 is a further screenshot depicting an example user interface 500 of a first software application in which a visual representation 526 of a process associated with a business object of a second application is presented. The business-object-analysis module 216 determines functionalities associated with the enterprise information management application and the business object that George can activate from within Microsoft Outlook. The business-object-analysis module 216 may make its determination based on a querying of the enterprise information management application or an analysis of a metamodel corresponding to the enterprise information management application. The presentation module 204 displays the available functionalities when George performs a particular action with respect to the visual representation of the business object (e.g., when George right clicks on the visual representation of the business object). In example embodiments, such actions are detected by the detection module 208. In the present example, one of the available functionalities of the enterprise information management application is the initiating of a collaborative decision-making task or process that relates to the business object. Having received the email message from Cicero providing positive feedback on Ute Goetz, George selects this functionality of the enterprise management application.

In response, the business-object-analysis module 216 may determine that George should provide additional data to start the collaborative decision-making process. For example, the business-object-analysis module 216 may determine that George should provide a title corresponding to the process. The presentation module 204 may then present a dialog box to collect the needed additional data from George. In this case, George provides a title of “Hire or Not Hire Ute Goetz?” The data-item-modification module 212 then adds a new data item to the business object that represents the collaborative decision-making process (e.g., via an API of the enterprise information management application). The presentation module 204 updates the visual representation 512 of the business object to include a visual representation 526 of the new data item (e.g., a square box containing the phrase “Hire or not hire Ute Goetz”). Note that the presentation module 204 may use color-coding to distinguish between different visual representations (e.g., a visual representation of a business object may be red, a visual representation of a task may be yellow, a visual representation of a folder may be dark blue, and a visual representation of a data item may be light blue). Additionally, the presentation module 204 may display icons in a visual representation to show whether the visual representation is expandable or collapsible (e.g., to show or hide visual representations of sub-items corresponding to the visual representation of an item).

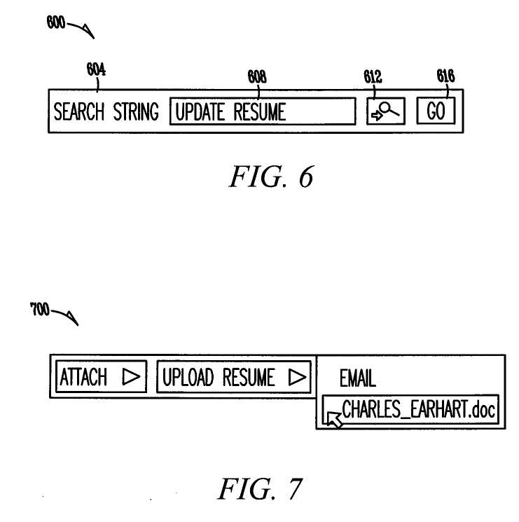

FIG. 6 is a screenshot depicting a portion of an example user interface 600 presented by a plug-in (e.g., plug-in 112) of a first software application (e.g., application 108) to enable a user to search for one or more business objects (e.g., business object 166) of a second software application (e.g., application 162) from within the first software application. The example user interface 600 includes a label 604 that labels a user-configurable field of a query. In this case, the user-configurable field of the query relates to searching for particular text within data items or metadata associated with the business objects of the second software application; therefore, the label is “Search String.” The example user interface 600 also includes a text box 608 in which a user may specify a value of the user-configurable field. The text box 608 may be pre-populated with a value based on an interaction of the user with respect to a data item of the first application. In this example, the text box 608 is pre-populated with the keywords “Updated resume,” as a result, for example, of an action by the user in the first application with respect to an email message containing an updated resume.

The example user interface 600 further includes a selection button 612 that allows a user to cycle through pre-defined values associated with the user-configurable field to be displayed in the text box 608. For example, a user may click on the selection button 612 to be presented with the next set of keywords in a plurality of sets of keywords that are associated with a data item that is the focus of an action of the user with respect to the first application. For example, clicking on the selection button 612 may cause keywords associated with the subject line, From: line, or To: line of an email message that is the focus of the first application to be cycled through the text box 608. The example user interface 600 may also include a button 616 (e.g., “Go”) that submits the query based on the current value of the user-definable field of the query reflected in the text box 608. The metadata table 132 may include specifications as to which fields of a search query are displayed in the query user interface, as well as metadata corresponding to the fields (e.g., labels, default values, etc., of the fields).

FIG. 7 is a screenshot depicting a portion 700 of an example user interface presented by a plug-in (e.g., the plug-in 112) of a first software application (e.g., the application 108) to enable a user to perform one or more actions related to the business object 166 of a second application (e.g., the application 162) from within the first application. The user interface 700 includes a menu that comprises menu items corresponding to actions that the user can perform. In this example, the user can perform an “Attach” action to attach a data item of the first application to a business object of the second application. That is, the user can perform an “Attach” action to upload an email message containing a resume or an attachment to the email message containing the resume to a location where it can be attached to the business object. The user may choose between uploading the entire email message or an attachment to the email message (e.g., “Charles_Earhart.doc”). The actions that a user can perform with respect to the business object may be defined by the application that provides the business object or defined in a metamodel associated with the business object.

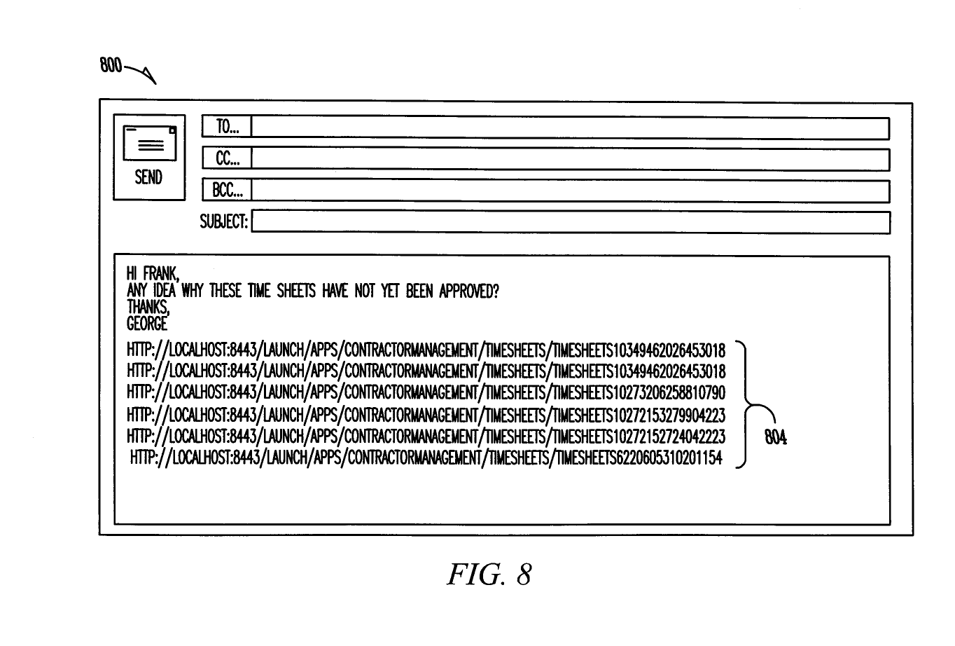

FIG. 8 is a screenshot depicting an example user interface 800 of a first software application in which a data item of the first application has been updated based on multiple data items of a business object of a second application. In this example, the first application is an email client (e.g., Microsoft Outlook) and the second application is an enterprise information management application that manages information related to contractors hired by a company. George, a recruiter at the company, receives an email message from Charles, who has been hired by the company as a contractor. In the email message, George states that he is concerned that some of his timesheets have not yet been approved, asking George to check with the responsible program manager. George uses the query user interface presented by presentation module 204 to find a business object of the enterprise information management application that corresponds to data about Charles.

The business-object-searching module 220 finds the business object based on the query and displays a visual representation of the business object (e.g., a “Person Earhart” business object) and its associated data items. One set of business items associated with the business object includes Charles' timesheets, which are organized into a folder (e.g., a “Timesheets” folder). George may view fields or elements containing data or metadata associated with the data items for the time sheets, noticing that some of the time sheets have a status “pending re-submission.” George may also identify from the fields or elements that the responsible program manager is Frank. George may then write a note to Frank to ask why the timesheets have not been approved. George may also drag and drop visual representations of the data items corresponding to the timesheets in question onto the email message. In response, the data-item-modification module 212 inserts into the email message Uniform Resource Locators (URLs) 804 from which each of the timesheets in question can be accessed by Frank via a web client (e.g., Microsoft Internet Explorer). The business-object-analysis module 220 may retrieve the URLs 804 from the application that provides the business object (e.g., via an API) or from a metamodel associated with the business object. In this example, FIG. 8 depicts the end result of George having dragged and dropped visual representations of the data items corresponding to the timesheets in question (e.g., a subset of the timesheets depicted in FIG. 3) onto the visual representation of the body of the email message (e.g., the email message 304 of FIG. 3), as presented by the presentation module 204.

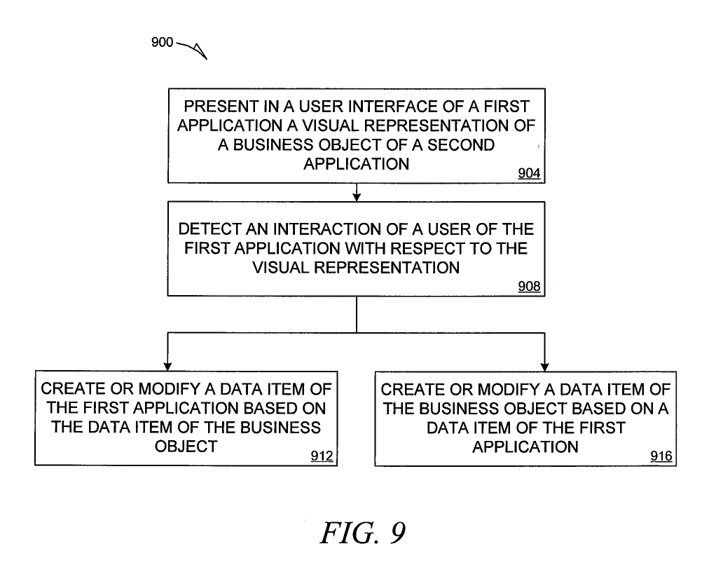

FIG. 9 is a flowchart depicting an example method 900 of creating or modifying a data item (e.g., data item 116) of a first application (e.g., application 108) based on a data item (e.g., data item 170) of a business object (e.g., business object 166) of a second application (e.g., application 162) or creating or modifying the data item of the business object based on the data item of the first application. At operation 904, the presentation module 204 presents a visual representation of a business object of a second application in a user interface of a first application. The presentation module 204 may also present visual representations of data items associated with the business object and visual representations of the relationships between the business object and the data items or between the data items.

At operation 908, the detection module 208 detects an interaction of a user of the first application with respect to the visual representation. For example, the detection module 208 may detect a dragging and dropping by the user of a visual representation of a data item (e.g., an email message) of the first application over the visual representation of the business object of the second application.

At operation 912, the data-item-modification module 212 creates or modifies a data item of the first application based on a data item of the business object or the data-item-modification module 212 creates or, at operation 916, the data-item-modification module 212 modifies a data item of the business object based on a data item of the first application. For example, if the detection module 208 detects that a user has dragged and dropped a visual representation of a data item of the first application onto a visual representation of the data item of the business object, the data-item-modification module 212 may modify the data item of the business object based on the data item of the first application. Additionally, if the detection module 208 detects that a user has dragged and dropped a visual representation of a data item of the business object onto a visual representation of the data item, the data-item-modification module 212 may modify the data item of the first application based on the data item of the business object. The modifying may include updating one or more portions of a first data item based on a second data item or replacing the first data item with the second data item such that the first data item and the second data item are in synchronization.

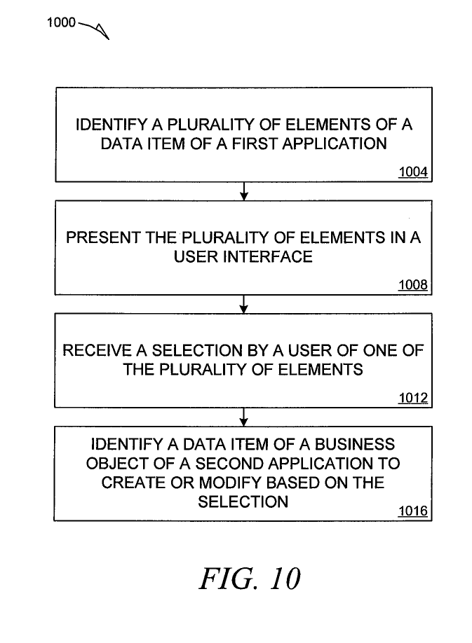

FIG. 10 is a flowchart depicting an example method 1000 of creating or modifying a data item of a business object of a second application based on a selection by a user of one of a plurality of elements of a data item of a first application. At operation 1004, the correspondence module 224 identifies a plurality of elements of a data item of a first application. For example, if the data item is an email message, the correspondence module 224 may identify that the email message includes elements defining the sender of the message, the recipient of the message, the subject of the message, the body of the message, one or more attachments of the message, and the header associated with the message.

At operation 1008, the presentation module 204 presents (e.g., in response to a detection by the detection module 208 of an action by the user with respect to a visual representation of the data item or a visual representation of a business object) one or more of the plurality of elements of the data item in a user interface (e.g., a menu or a dialog box) for selection by the user as an element upon which to base an updating of the business object. For example, the presentation module 204 may present the user with a menu that enables the user to select between updating a business object based on a body of an email message or updating the business object based on an attachment to the email message.

At operation 1012, the detection module 208 receives a selection by the user of one of the plurality of elements. For example, the detection module 208 receives a selection by the user of an attachment element of an email message. In this way, the user indicates that the data item of the business object should be updated based on the email attachment.

At operation 1016, the correspondence module 224 identifies a data item of the business object to create or modify based on the selection. For example, if the user selects to update the business object based on an attachment to the email message, the correspondence module 224 may identify a new data item to create for the business object within which to store or categorize the attachment (e.g., a folder) as well as a new data item within which to store the attachment itself.

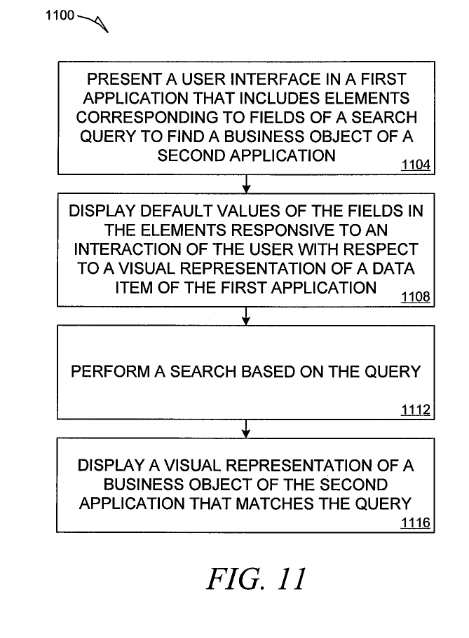

FIG. 11 is a flowchart depicting an example method 1100 of displaying a visual representation of a business object of a second application that matches a query submitted by a user via a user interface of the first application. At operation 1104, the presentation module 204 presents a user interface in a first application that includes elements corresponding to user-configurable fields of a search query to find a business object of a second application. The business-object-analysis module 216 may determine the business objects provided by the second application by querying the second application or analyzing a metamodel of the business objects or definitions of associations stored in operational data in operational data table 136. The business-object-analysis module 216 may also select user-configurable fields for presentation based on configuration data of the plug-in 112 stored in the metadata table 132.

At operation 1108, the presentation module 204 displays default values of the fields in the elements responsive to an interaction of the user with respect to a visual representation of a data item of the first application 108. For example, in response to detection by the detection module 208 of an opening of an email message in the first application, the presentation module 204 may display the email address of the sender of the email message as a default value for a Search String field of a query for finding a business object of the second application that is related to the email message.

At operation 1112, the business-object-searching module 220 performs a search for the business object of the second application based on the query. For example, the business-object-searching module 220 may send the query to the application that provides a plurality of business objects for processing. Alternatively, the business-object-searching module 220 may find a business object of the second application based on an analysis of a metamodel associated with the second application. At operation 1116, the presentation module 204 displays a visual representation of a business object of the second application that matches the query.

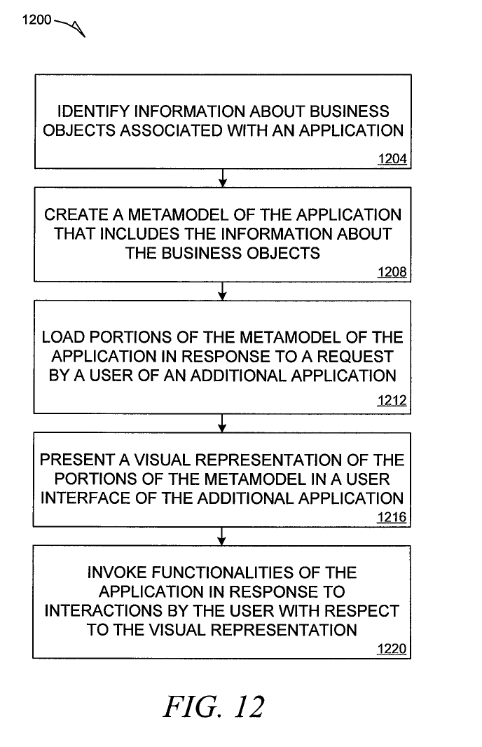

FIG. 12 is a flowchart depicting an example method 1200 of invoking functionalities of an application based on interactions of a user in an additional application with respect to visual representations of portions of a metamodel of the application presented in the additional application. At operation 1204, the business-object-analysis module 216 identifies information about business objects associated with an application. For example, the business-object-analysis module 216 identifies labels of the data items associated with the business object (e.g., first name, last name, email address, and so on) as well as the values of the data items. The business-object-analysis module 216 also identifies metadata associated with the business object (e.g., the category of the business object, the type of the business object). The business-object-analysis module 216 may also identify relationships between the business object and the data items and between the data items. Furthermore, the business-object-analysis module 216 may identify the information based on a querying of an application that provides the business object.

At operation 1208, the business-object-analysis module 216 creates a metamodel of the application that includes the information about the business objects. In example embodiments, the plug-in 112 accesses the information without querying the application for the information again.

At operation 1212, the business-object-analysis module 216 loads portions of the metamodel of the application in response to a request by a user of an additional application. For example, when the detection module 208 detects an action of the user with respect to an email message, the business-object-analysis module 216 loads a portion of the metamodel containing data related to the email message (e.g., a business object corresponding to a person who sent the email message). The business-object-analysis module 216 may also load a portion of the metamodel corresponding to one or more data items of the business object.

At operation 1216, the presentation module 204 presents a visual representation of the portions of the metamodel in a user interface of the additional application.

At operation 1220, the data-item-modification module 212 invokes one or more functionalities of the application in response to one or more interactions by the user with respect to the visual representation. For example, in response to detection by the detection module 208 of a dragging and dropping of an email message over a visual representation of a business object corresponding to the email message, the data-item-modification module 212 may invoke a functionality of the application to attach the email message (or an attachment of the email message) to a data item of the business object.

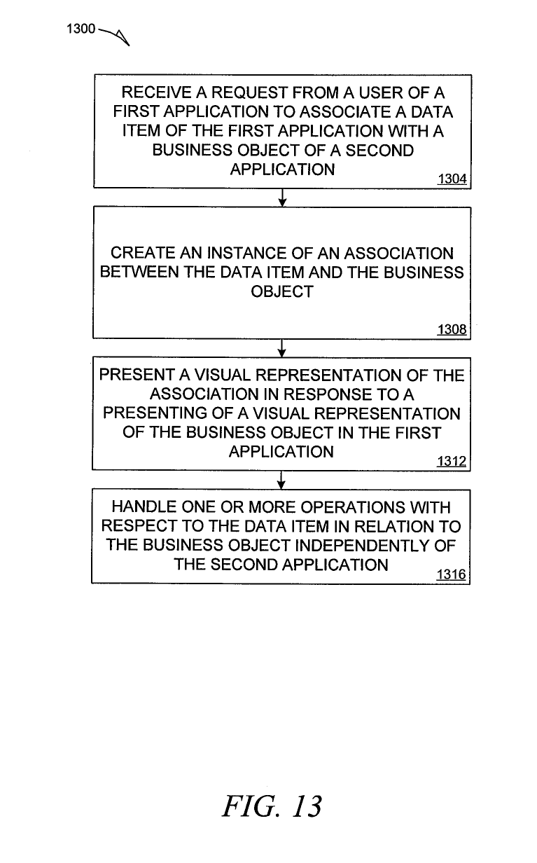

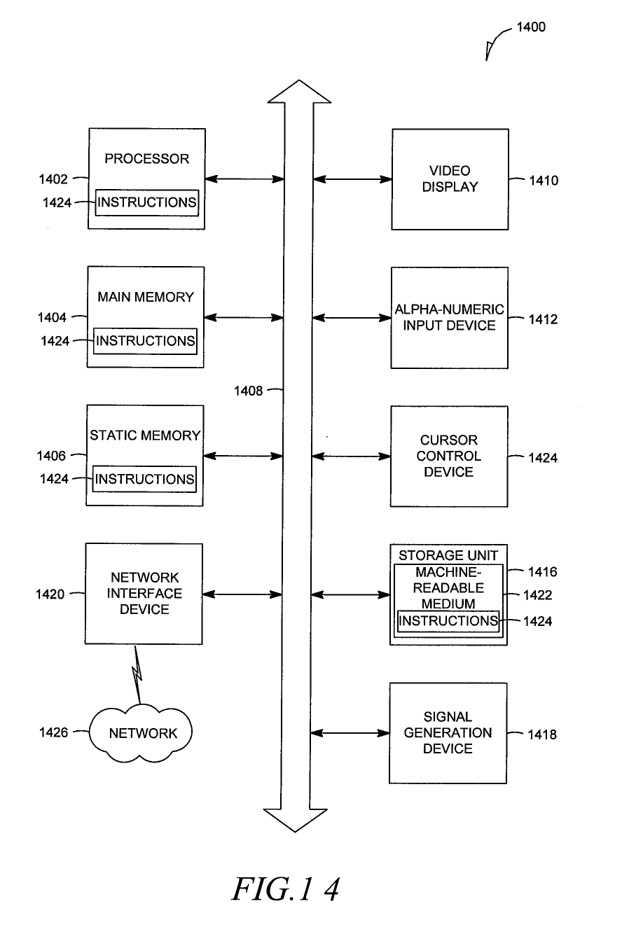

FIG. 13 is a flowchart depicting an example method 1300 of associating a data item of a first application with a data item of a business object of a second application. At operation 1304, the detection module 208 receives a request from a user of a first application to associate a data item of the first application with a business object of a second application. For example, the detection module 208 may detect a dragging and dropping of the data item of the first application onto a visual representation of the business object, such as a visual representation of the business object presented by the presentation module 204 in the first application. In other words, the detection module 208 may interpret an action by the user with respect to the visual representation of the business object in the first application to be a request by the user to associate the data item of the first application with the business object of the second application. Additionally or alternatively, the detection module 208 may receive the request from the user via another mechanism (e.g., a selection by the user of a menu item presented by the presentation module 204 in the first application or an invoking of an API by the user).

At operation 1308, the data-item-modification module 212 creates an instance (e.g., a definition or description) of an association between the data item of the first application and the business object of the second application (or a data item of the business object of the second application). The data-item modification module 212 may associate the instance with the metamodel corresponding to the business object. The metamodel may include descriptions of all possible associations between the business object and additional business objects or data items. For example, the data-item-modification module 212 may create a definition that specifies that the data item is associated with the business object. The definition may include information about the data item, such as for example, a location of the data item, a type of the data item, and a category of the data item. The data-item-modification module 212 may store the definition in a database table (e.g., operational data table 136).

At operation 1312, the presentation module 204 may present a visual representation of the association in response to a presenting of a visual representation of the business object in the first application. For example, the user may enter a query that returns the business object, which results in the presentation module 204 presenting a visual representation of the business object in the first application. This presenting of the visual representation of the business object may include a presenting by the presentation module 204 of a visual representation of the association of the business object to the data item in the first application. In other words, if the metamodel includes a definition that specifies that the data item is related to the business object at a first degree (in other words, that there are no additional data items between the business object and the data item), the presentation module 204 may present a visual representation of the business object that includes a visual representation of a connector (e.g., a line) between the business object and a visual representation of the data item.

At operation 1316, the data-item-modification module 212 handles one or more operations with respect to the data item in relation to the business object independently of the second application. For example, if the user specifies that the data item should be updated with respect to the business object, the data-item-modification module 212 handles the updating independently of the second application. In other words, the data item corresponding to the business object as well as the relationship between the business object and the data item is maintained by the data-item-modification module 212 (e.g., in the operational data table 136) as an annotation of the business object. In fact, the second application may be unaware of the existence of an association between the business object of the second application and the data item of the first application.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 120) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 14 is a block diagram of machine in the example form of a computer system 1400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a user interface (UI) navigation (or cursor control) device 1414 (e.g., a mouse), a disk drive unit 1416, a signal generation device 1418 (e.g., a speaker) and a network interface device 1420.

### Machine-Readable Medium

The disk drive unit 1416 includes a machine-readable medium 1422 on which is stored one or more sets of instructions and data structures (e.g., software) 1424 embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media. The instructions 1424 may also reside, completely or at least partially, within the static memory 1406.

While the machine-readable medium 1422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1424 may further be transmitted or received over a communications network 1426 using a transmission medium. The instructions 1424 may be transmitted using the network interface device 1420 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A non-transitory machine readable medium embodying a set of instructions that, when executed by a processor, causes the processor to perform a method, the method comprising:
presenting in a user interface of a first application a visual representation of a business object of a second application, the business object pertaining to a functionality of the second application;
detecting, using a processor, an interaction of a user of the first application with respect to the visual representation of the business object; and
in response to the detecting, performing at least one of:
creating or modifying a data item of the first application based on a data item of the business object of the second application; and
creating or modifying the data item of the business object of the second application based on the data item of the first application.

2. The non-transitory machine readable medium of claim 1, wherein the creating or modifying of the data item of the first application or the creating or modifying of the data item of the business object of the second application includes synchronizing the data item of the first application with the data item of the business object of the second application.

3. The non-transitory machine readable medium of claim 1, wherein the detecting of the interaction includes detecting a single drag-and-drop operation, the single drag-and-drop operation including dragging a visual representation of the data item of the first application and a dropping of the visual representation of the data item of the first application on the visual representation of the business object or a visual representation of the data item of the business object.

4. The non-transitory machine readable medium of claim 1, wherein the method further comprises determining an address of a location at which the second application publishes information pertaining to the data item of the business object, wherein the creating or modifying the data item of the first application includes inserting the address into the data item of the first application.

5. The non-transitory machine readable medium of claim 1, wherein the creating or modifying of the data item of the business object includes using an application program interface (API) associated with the business object.

6. The non-transitory machine readable medium of claim 1, wherein the method further comprises determining that an element of the data item of the first application corresponds to the business object.

7. The non-transitory machine readable medium of claim 6, wherein:
the data item of the first application is an email message;
the element of the data item of the first application is an attachment to the email message, the attachment including particular information about a person;
the business object corresponds to the person; and
the data item of the business object corresponds to the particular information about the person.

9. The non-transitory machine readable medium of claim 1, wherein the method further comprises:
identifying a plurality of elements of the data item of the first application;
presenting the plurality of elements in the user interface; and
receiving a selection by the user of one of the plurality of elements,
wherein the creating or modifying of the data item of the business object includes updating the data item of the second application based on the one of the plurality of the elements.

10. The non-transitory machine readable medium of claim 1, wherein the method further comprises:
receiving a specification of a relationship between at least one of the business object and an additional business object and the data item of the second application and an additional data item of the second application;
adding the specification of the relationship to a metamodel; and
presenting a visual representation of the relationship in the first application based on the metamodel.

11. The non-transitory machine readable medium of claim 1, wherein the method further comprises displaying in the user interface of the first application a plurality of user interface elements corresponding to a plurality of fields of a search query to find the business object.

12. The non-transitory machine readable medium of claim 11, wherein the plurality of fields includes one or more of a field corresponding to an identifier of a business object repository, a field corresponding to a type of a business object, and a field corresponding to a text string.

13. The non-transitory machine readable medium of claim 11, wherein the method further comprises:
determining a default value corresponding to at least one of the plurality of search fields based on the data item of the first application; and
displaying the default value in one of the plurality of user interface elements corresponding to the one of the plurality of search fields.

14. The non-transitory machine readable medium of claim 1, wherein the method further comprises:
detecting a relationship between the business object and the data item of the second application;
displaying a visual representation of the data item of the second application; and
displaying a visual representation of the relationship between the business object and the data item of the second application.

15. The non-transitory machine readable medium of claim 14, wherein the detecting of the relationship includes referring to a database corresponding to the first application, the database including a definition of the relationship that the first application maintains independently of the second application.

16. A system comprising:
a presentation module to present in a user interface of a first application a visual representation of a business object of a second application, the business object being an object that encapsulates a functionality of the second application;
a detection module to detect, using a processor, an interaction of a user of the first application with respect to the visual representation of the business object; and
a data-item-modification module to, in response to the detecting, perform at least one of:
creating or modifying a data item of the first application based on a data item of the business object; and
creating or modifying the data item of the business object based on the data item of the first application.

17. The system of claim 16, further comprising a correspondence module to determine that an element of the data item of the first application corresponds to a data item of the second application.

18. The system of claim 17, wherein:
the data item of the first application is an email message;
the element of the data item of the first application is an attachment to the email message, the attachment including particular information about a person;
the business object relates to a maintenance of information about the person; and
the data item of the business object corresponds to the particular information about the person.

19. A method comprising:
presenting in a user interface of a first application a visual representation of a business object of a second application, the business object being an object that encapsulates a functionality of the second application;
detecting, using a processor, an interaction of a user of the first application with respect to the visual representation of the business object; and
in response to the detecting, performing at least one of:
creating or modifying a data item of the first application based on a data item of the business object; and
creating or modifying the data item of the business object based on the data item of the first application.

20. The method of claim 19, further comprising determining an address of a location at which the second application publishes information pertaining to the data item of the business object, wherein the creating or modifying the data item of the first application includes inserting the address into the data item of the first application.
